(19) United States
(12) Patent Application Publication
(10) Pub. No.: US 2016/0118708 A1
(43) Pub. Date: Apr. 28, 2016

(54) ANTENNA DEVICE

(71) Applicant: Asahi Glass Company, Limited, Chiyoda-ku (JP)

(72) Inventors: Kotaro Suenaga, Chiyoda-ku (JP); Osamu Kagaya, Chiyoda-ku (JP); Koji Ikawa, Chiyoda-ku (JP)

(73) Assignee: Asahi Glass Company, Limited, Chiyoda-ku (JP)

(21) Appl. No.: 14/990,853

(22) Filed: Jan. 8, 2016

Related U.S. Application Data
(63) Continuation of application No. PCT/JP2014/068926, filed on Jul. 16, 2014.

(30) Foreign Application Priority Data
Jul. 31, 2013 (JP) 2013-159258

(51) Int. Cl. H01Q 1/12; H01Q 7/00

(52) U.S. Cl. CPC H01Q 1/1271; H01Q 7/00

(57) ABSTRACT

An antenna device includes an antenna conductor on windshield glass, a feeding point having adjacent first and second feeding parts on the antenna conductor, and an auxiliary conductor including electrically connected horizontal and vertical conductors. The antenna conductor is adjacent to a connecting part between the horizontal and vertical conductors, and has a semi-loop shape with a cutout part in a loop-shape. The feeding point is located along the horizontal conductor, and the cutout part is located opposite from the horizontal conductor with respect to a horizontal line passing through a center point of a region surrounded by a semi-loop element, and opposite from the vertical conductor with respect to a vertical line passing through the center point. A length of a first element forming a part of the antenna conductor is 0.2λ_{g} or greater and 0.35λ_{g} or less, where λ_{g} denotes a wavelength on the windshield glass.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2014/068926 filed on Jul. 16, 2014, which is based upon and claims the benefit of priority of Japanese Patent Application No. 2013-159258 filed on Jul. 31, 2013, the entire contents of which are incorporated herein by reference.

### BACKGROUND OF THE INVENTION

1. Field of the Invention

The present invention relates to an antenna device for automotive glass.

2. Description of the Related Art

An ITS (Intelligent Transport System) utilizing radio waves in the 700 MHz band, which is one of inter-vehicle communications under consideration, uses vertical polarized waves polarized in a direction perpendicular to the ground surface. In order to efficiently perform transmission and reception in the inter-vehicle communication, a high receiving sensitivity is required with respect to the vertical polarized waves, and an increase in a gain with respect to a front direction of the vehicle is required.

An antenna having the above characteristics is proposed in Japanese Laid-Open Patent Publication No. 2009-100053, for example. The Japanese Laid-Open Patent Publication No. 2009-100053 proposes an antenna having a loop shape formed by a first main line that has a feeding point at a central part thereof, a second main line that is provided at a position different from that of the first main line, and two connecting lines connecting ends of the two main lines, with a reactance element that is provided on the connecting lines.

However, according to the antenna of the Japanese Laid-Open Patent Publication No. 2009-100053, because of the configuration that is used to obtain the high transmitting and receiving performance with respect to the vertical polarized waves, the feeding point needs to be provided at the central part of the main line that transmits and receives the vertical polarized waves. In other words, in a case in which the antenna is arranged on a front windshield for an automobile, a pillar-feeding is required in which the feeding point is arranged adjacent to a pillar of the automobile. For this reason, in a case in which a roof-feeding is required in which the feeding point is arranged on a roof of the automobile due to the vehicle body design, the pillar-feeding cannot be employed, and the freedom of design of the antenna is limited. In addition, a conductor extending in the vertical direction is suited for transmitting and receiving the vertical polarized waves, however, the configuration in which the feeding point is near a conductor extending in a horizontal direction, such as along the roof, is unsuited for transmitting and receiving the vertical polarized waves.

### SUMMARY OF THE INVENTION

Accordingly, one object of the embodiments is to provide an antenna device having a high receiving sensitivity with respect to vertical polarized waves and having a directivity in a front direction of a vehicle, and enabling a roof-feeding.

According to one aspect of the embodiments, an antenna device includes an antenna conductor provided on windshield glass, a feeding point having a first feeding part and a second feeding part that are provided on the antenna conductor and are arranged adjacent to each other, and an auxiliary conductor, wherein the auxiliary conductor includes a horizontal conductor linearly provided in a horizontal direction, and a vertical conductor electrically connected to the horizontal conductor and linearly provided in a vertical direction; the antenna conductor includes a first element that is arranged adjacent to a connecting part between the horizontal conductor and the vertical conductor and has one end connected to the first feeding part, and a second element that has one end connected to the second feeding part; the feeding point is located at a position along the horizontal conductor of the antenna conductor; another end of the first element and another end of the second element are arranged adjacent to each other and a cutout part is formed in a part of a loop shape, to form a semi-loop element by the first element and the second element; the cutout part is provided on an opposite side from the horizontal conductor with respect to a horizontal line passing through a center point of a region surrounded by the semi-loop element, and on an opposite side from the vertical conductor with respect to a vertical line passing through the center point; and a length of the first element is greater than or equal to 0.22λ_{g} and less than or equal to 0.35λ_{g}, where λ₀ denotes a wavelength in air at a center frequency of a predetermined frequency band, k denotes a wavelength shortening coefficient of the windshield glass, and λ_{g}=λ₀·k denotes a wavelength on the windshield glass.

Other objects and further features of the present invention will be apparent from the following detailed description when read in conjunction with the accompanying drawings.

### BRIEF DESCRIPTION OF THE DRAWINGS

FIG. 1A is a plan view illustrating a mounting position of an antenna conductor 101 in a first embodiment of the present invention in a case in which a roof 106 is regarded as a horizontal conductor and a pillar 105 is regarded as a vertical conductor;

FIG. 1B is a plan view illustrating the mounting position of the antenna conductor 101 in the first embodiment of the present invention in a case in which the roof 106 is regarded as the horizontal conductor and a conductor 108v is regarded as the vertical conductor;

FIG. 1C is a plan view illustrating the mounting position of the antenna conductor 101 in the first embodiment of the present invention in a case in which a conductor 108h is regarded as the horizontal conductor and the conductor 108v is regarded as the vertical conductor;

FIG. 1D is a plan view illustrating the mounting position of the antenna conductor 101 in the first embodiment of the present invention in a case in which the roof 106 is regarded as the horizontal conductor and the pillar 105 and a conductor 110 are regarded as the vertical conductor;

FIG. 2 is a plan view of a glass antenna in the first embodiment of the present invention;

FIG. 3A is a plan view of the glass antenna in a second embodiment of the present invention;

FIG. 3B is a plan view illustrating a modification of the glass antenna in the second embodiment of the present invention;

FIG. 3C is a plan view illustrating a modification of the glass antenna in the second embodiment of the present invention;

FIG. 4 is a plan view of the glass antenna in a third embodiment of the present invention;

FIG. 5 is a diagram schematically illustrating a current flow and an electric field radiating direction in a loop element;

FIG. 6 is a diagram schematically illustrating the current flow and the electric field radiating direction in a semi-loop element;

FIG. 7 illustrates measured data of directivity of the loop element and the semi-loop element;

FIG. 8 is a plan view of the glass antenna forming the semi-loop element having an overlapping part 803;

FIG. 9 illustrates measured data of effects of the overlapping part 803 on the directivity;

FIG. 10 is a diagram of an analyzing model viewed from above a vicinity of an intersection;

FIG. 11 is a diagram illustrating a relationship between an angle at which a cutout part 205 is provided and a reception rate;

FIG. 12 is a diagram illustrating a relationship between a length of a first element and a reception gain for a case 1;

FIG. 13 is a diagram illustrating the relationship between the length of the first element and the reception gain for a case 2;

FIG. 14 is a diagram illustrating the relationship between the length of the first element and the reception gain for a case 3;

FIG. 15 is a diagram illustrating a relationship between a distance from the pillar 105 and the reception rate;

FIG. 16 is a diagram illustrating a relationship between a distance from the roof 106 and the reception rate;

FIG. 17 is a diagram illustrating a relationship between an aspect ratio of the semi-loop element and the reception rate;

FIG. 18 is a diagram illustrating a relationship between a circumference of the semi-loop element and the reception rate; and

FIG. 19 is a diagram illustrating a relationship of a loop forming element 304 and an overlap forming element 305 with respect to the reception rate, for a case in which measurements of antenna conductors 101, 301b, and 301c are made under the same conditions.

### DESCRIPTION OF THE PREFERRED EMBODIMENTS

A description will hereinafter be given of embodiments of the present invention with reference to the drawings. In the drawings used to describe the embodiments, parallel lines, perpendicular lines, curvatures of corner parts, or the like may tolerate an error to a certain extent that does not impair the effects of the present invention. In addition, the drawings illustrate automotive windshield glass 102 which will be described later, in a state mounted on a vehicle and viewed from inside the vehicle, however, the drawings may be referred to as illustrating the state viewed from outside the vehicle. Further, in the drawings, right and left directions correspond to a direction along a width of the vehicle, and will be referred to as a horizontal direction. Moreover, in the drawings, up and down directions correspond to a direction along a height of the vehicle, and will be referred to as a vertical direction. In the following description, coordinates are defined by arrows at a bottom left of the drawings, and a reference is made to the coordinates where necessary.

### First Embodiment

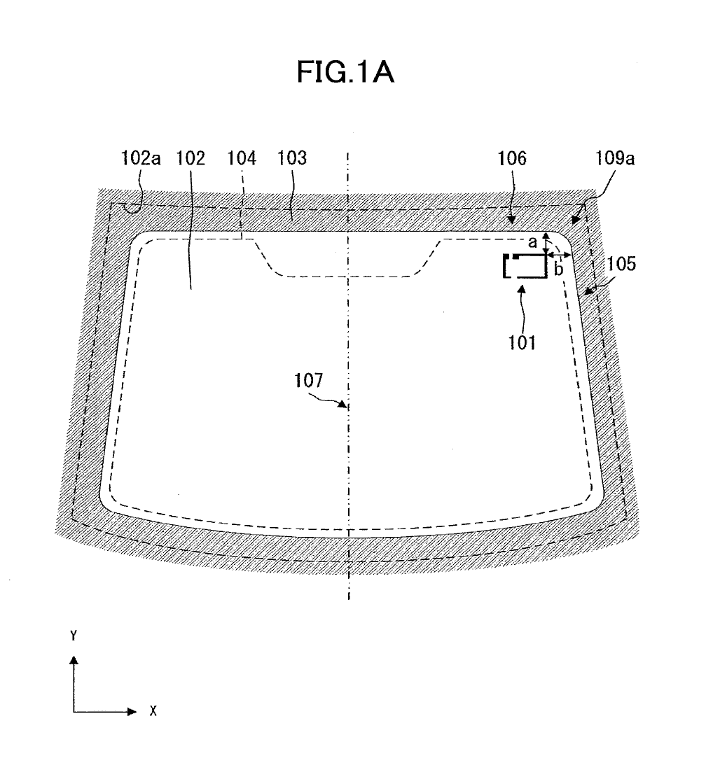

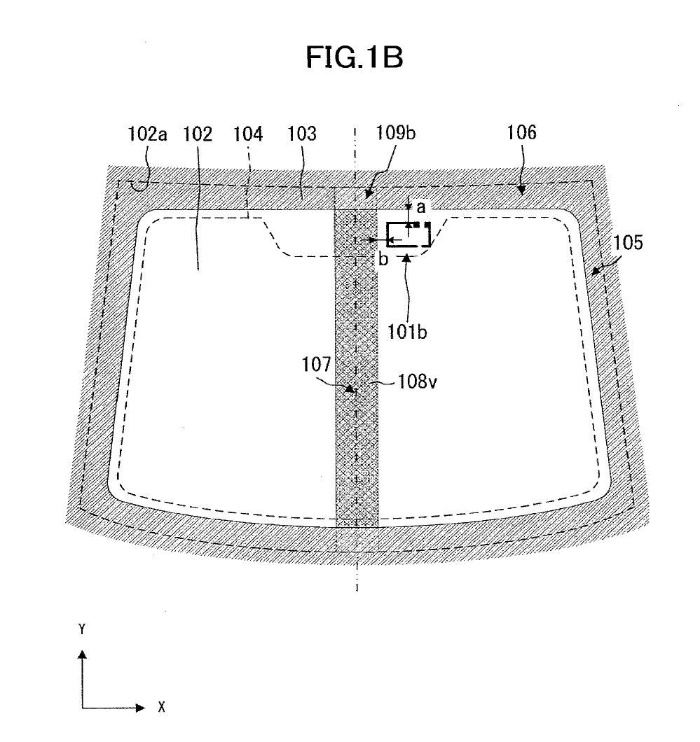

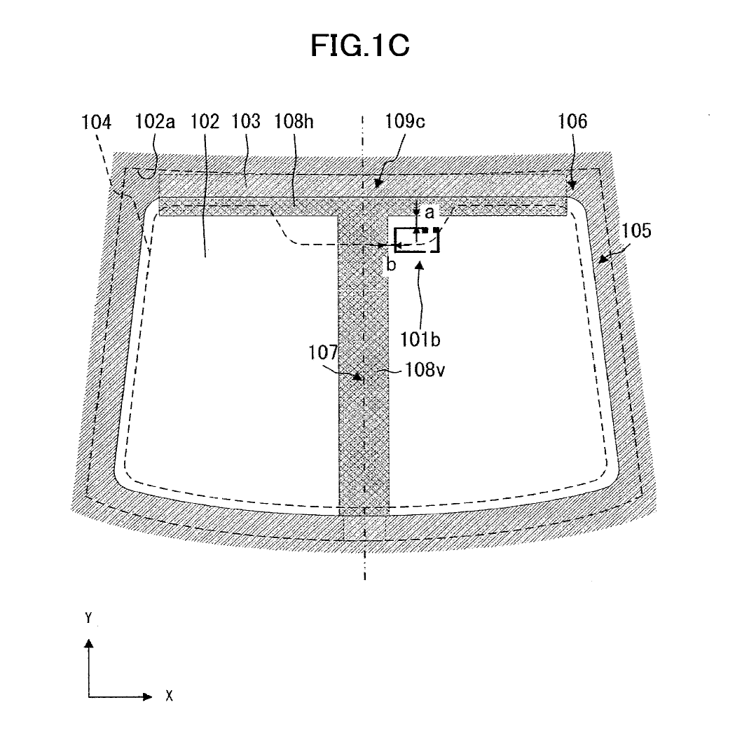

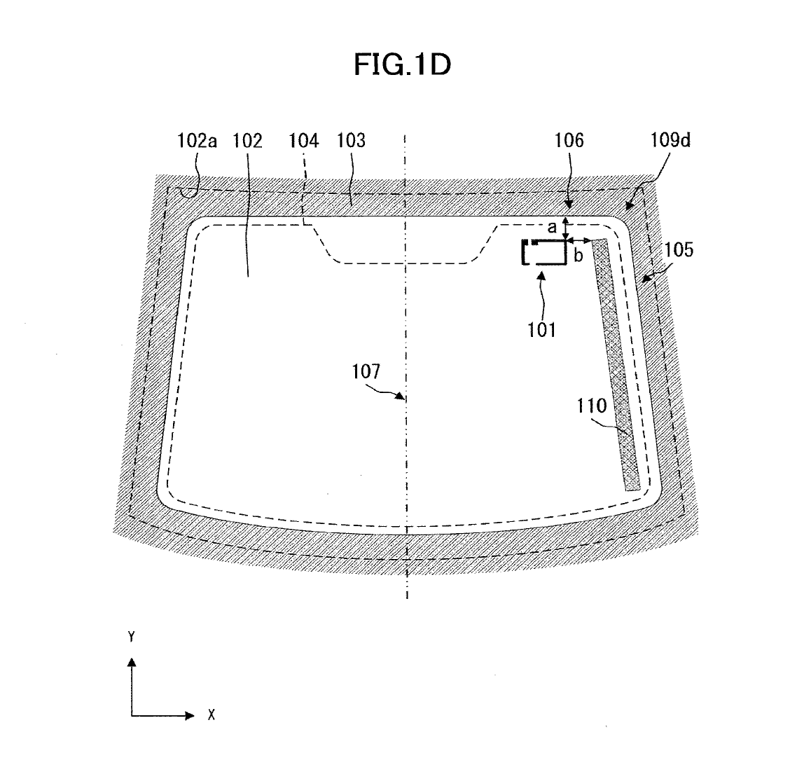

FIG. 1 illustrates plan views of an antenna device in a first embodiment of the present invention. In FIG. 1, the automotive windshield glass 102 is illustrated in a state mounted on the vehicle and viewed from inside the vehicle. The automotive windshield glass 102 is provided on a metal flange 103 that forms a windshield opening of a vehicle body. In addition, the automotive windshield glass 102 is provided with a black concealing layer 104 in a region having a predetermined width from an outer edge 102a of the automotive windshield glass 102, in order to conceal a bonding part with respect to the metal flange 103 of the vehicle body, from a viewpoint of preventing deterioration of an adhesive and from a viewpoint of providing beautiful appearance. Although FIG. 1 illustrates an example in which the black concealing layer 104 is provided, the black concealing layer 104 may be omitted if unnecessary.

The antenna device in this embodiment includes an antenna conductor 101, a feeding point provided on the antenna conductor 101 and including a first feeding part and a second feeding part that are adjacent to each other, and an auxiliary conductor.

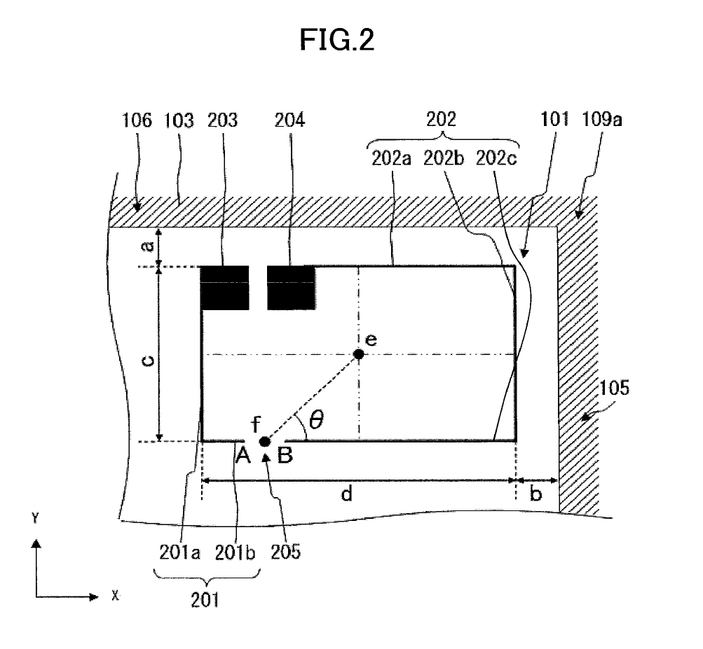

The auxiliary conductor includes a horizontal conductor provided linearly in the horizontal direction, and a vertical conductor electrically connected to the horizontal conductor and provided linearly in the vertical direction. The horizontal conductor and the vertical conductor form a T-shape, an L-shape, or a cross shape. The feeding point and the auxiliary conductor will be described later in more detail in conjunction with FIG. 2 and the subsequent figures.

The antenna conductor 101 is provided in a vicinity of a connecting part of the horizontal conductor and the vertical connector. The feeding point is located at a part along the horizontal conductor of the antenna conductor. The vicinity of the connecting part refers to the vicinity of the connecting part where the horizontal conductor and the vertical conductor overlap in the plan view. A distance a (hereinafter referred to as “distance a from the horizontal conductor”) between the horizontal conductor and a part of the antenna conductor 101 closest to the horizontal conductor is desirably 0.27λ_{g} or less, in a case in which a wavelength in air at a center frequency of a predetermined frequency band is denoted by λ₀, a wavelength shortening coefficient of the automotive windshield glass 102 is denoted by k, and a wavelength on the automotive windshield glass 102 is denoted by λ_{g}=λ₀·k.

For example, in a case in which the inter-vehicle communication is set as the desired frequencies, the center frequency of the inter-vehicle communication is 760 MHz. Accordingly, in order to improve an antenna gain of the inter-vehicle communication, the distance a from the horizontal conductor is desirably 70 mm or less, when a velocity of the radio wave is 3.0×10⁸ m/s and the wavelength shortening coefficient k is 0.64.

In addition, a distance b (hereinafter referred to as “distance b from the vertical conductor”) between the vertical conductor and a part of the antenna conductor 101 closest to the vertical conductor is desirably 0.19λ_{g} or less, from a viewpoint of improving the receiving sensitivity of the vertical polarized waves. For example, in a case in which the ITS having a center frequency of 760 MHz is considered, the distance b from the vertical conductor is desirably 50 mm or less.

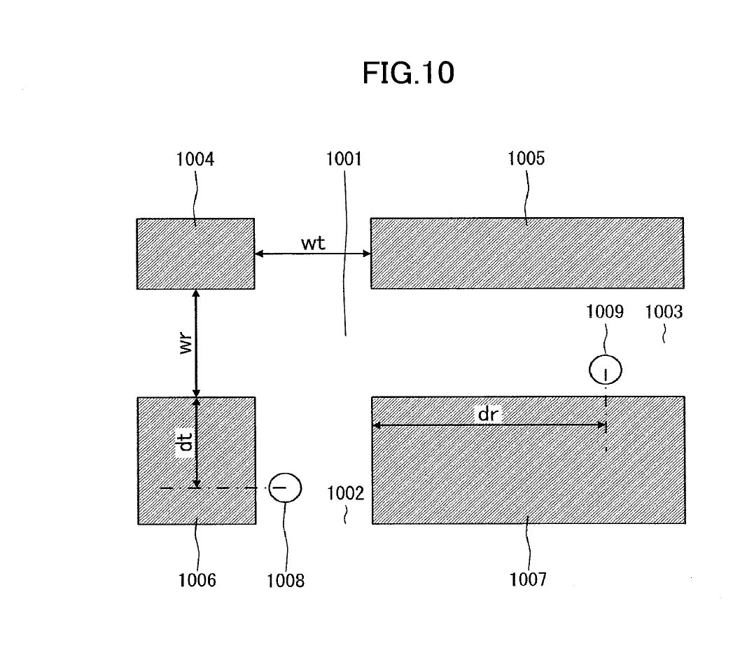

FIGS. 1A, 1B, 10, and 1D illustrate embodiments of a positional relationship of the antenna conductor 101 relative to the horizontal conductor and the vertical conductor. This arrangement position may be similarly applied to the arrangement positions of antenna conductors 301a, 301b, 301c, and 401 which will be described later. The horizontal conductor in this embodiment tolerates a horizontal error to a certain extent that does not impair the effects of the present invention, and may have a curvature along the shape of a flange on the roof side, particularly at the windshield opening of the vehicle body where the windshield glass is provided. In addition, the vertical conductor in this embodiment tolerates a vertical error to a certain extent that does not impair the effects of the present invention, and may be provided at an inclination along the shape of a flange on the pillar side, particularly at the windshield opening of the vehicle body where the windshield glass is provided.

In FIG. 1A, the antenna conductor 101 is arranged in a vicinity of a connecting part 109a where a roof side flange 106 forming an upper side of the metal flange 103 of the vehicle and a pillar side flange 105 forming a side of the metal flange 103 of the vehicle connect at a predetermined angle. In the following description of the drawings, the side of the metal flange 103 will be referred to as the pillar 105, and the upper side of the metal flange 106 will be referred to as the roof 106. In the embodiment of FIG. 1A, the roof 106 corresponds to the horizontal conductor, and the pillar 105 corresponds to the vertical conductor, respectively. In a case in which the pillar 105 is provided at a predetermined angle greater than the perpendicular angle, the distance b from the vertical conductor of the antenna conductor 101 corresponds to a distance from an upper right end part of the antenna conductor 101 to the pillar.

In FIG. 1B, an antenna conductor (hereinafter referred to as “antenna conductor 101b”) having a pattern that is a mirror image (line symmetric with respect to a Y-direction axis) of the antenna conductor 101 of FIG. 1A along an X-direction is arranged in a vicinity of a connecting part 109b that connects to the conductor 108v provided on a centerline 107 extending in the up and down directions and passing through the roof 106 and a center of gravity of the automotive windshield glass 102. The roof 106 corresponds to the horizontal conductor, and the conductor 108v corresponds to the vertical conductor, respectively.

In the case of laminated glass having a first glass plate and a second glass plate that are laminated via an intermediate layer, the conductor 108v may be provided on the intermediate layer of the laminated glass, or may be provided on a surface of one of the two glass plates. The configuration in which the conductor 108v is provided on the intermediate layer may have the conductor 108v provided on the intermediate layer itself of the laminated glass, or may have the conductor 108v that is separate from the intermediate layer sandwiched between the two glass plates. In addition, the surface of one of the two glass plates may be an inner surface or an outer surface of each of the two glass plates of the laminated glass. It is particularly preferable that the conductor 108v is formed by a transparent conductor layer.

In addition, in the connecting part 109b, the roof 106 and the conductor 108v are electrically connected. The electrical connection may be either one of an AC coupling or a DC coupling, however, the DC coupling is particularly preferable. The AC coupling refers to a state in which, in the connecting part 109b, for example, the roof 106 and the conductor 108v are capacitively coupled in a direction of a thickness of the automotive windshield glass 102 or on the same plane, via an insulator. In the case of the capacitive coupling in the direction of the thickness, the roof 106 and the conductor 108v may overlap at the connecting part 109b as illustrated in FIG. 1B. In the case of the capacitive coupling on the same plane, the roof 106 and the conductor 108v may be separated at the connecting part 109b.

A length of the conductor 108v in the Y-direction is desirably long compared to a wavelength of the radio waves used for the transmission and reception, and the conductor 108v does not need to be provided for the entire length from the upper end to the lower end of the automotive windshield glass 102. In addition, the length of the conductor 108v in the X-direction is not limited to a particular value and may be set in a current capacity range in which the vertical polarized waves are obtainable, and is desirably short compared to the wavelength of the radio waves used for the transmission and reception.

FIG. 1C illustrates an example in which a conductor 108h is arranged in the horizontal direction, in addition to the configuration of FIG. 1B. The antenna conductor 101b is arranged in a vicinity of a connecting part 109c between the conductor 108h and the conductor 108v. In this case, the conductor 108h corresponds to the horizontal conductor, and the conductor 108v corresponds to the vertical conductor, respectively. In the case of the laminated glass having the first glass plate and the second glass plate that are laminated via the intermediate layer, the conductor 108h may be provided on the intermediate layer of the laminated glass, or may be provided on the surface of one of the two glass plates. It is particularly preferable that the conductor 108h and the conductor 108v are formed by a transparent conductor layer. The conductor 108h and the conductor 108v do not necessarily need to have the same configuration, and for example, the conductor 108h may be provided on the intermediate layer and the conductor 108v may be provided on the surface of one of the two glass plates, or vice versa.

In the connecting part 109c, the conductor 108h and the conductor 108v are electrically connected. The electrical connection may be either one of the AC coupling or the DC coupling, however, the DC coupling is particularly preferable. The AC coupling refers to a state in which, in the connecting part 109c, for example, the conductor 108h and the conductor 108v are capacitively coupled in the direction of the thickness of the automotive windshield glass 102 or on the same plane, via the insulator. In the case of the capacitive coupling in the direction of the thickness, the conductor 108h and the conductor 108v may overlap at the connecting part 109c. In the case of the capacitive coupling on the same plane, the conductor 108h and the conductor 108v may be separated at the connecting part 109c.

In FIG. 10, the conductor 108v and the conductor 108h connect to form a T-shape, however, the configuration is not limited to that illustrated in FIG. 10. For example, the conductor 108v and the conductor 108h may connect to form an L-shape or a cross shape. In addition, in a case in which a conductor other than the roof 106 is regarded as the horizontal conductor, as in this embodiment, the conductor 108h is preferably electrically connected to the roof 106 from the viewpoint of improving the antenna gain. When the conductor 108h and the roof 106 are in a positional relationship to electrically connect to each other, a roof-feeding becomes possible with respect to the antenna conductor 101.

FIG. 1D illustrates an example in which the conductor 110 is arranged on the glass surface on the inner side of the pillar 105. The antenna conductor 101 is arranged in a vicinity of a connecting part 109d between the roof 106 and the pillar 105. In this case, the roof 106 corresponds to the horizontal conductor, and because the pillar 105 and the conductor 110 are electrically connected, the pillar 105 and the conductor 110 as a whole corresponds to the vertical conductor, respectively. In the case of laminated glass having the first glass plate and the second glass plate that are laminated via the intermediate layer, the conductor 110 may be provided on the intermediate layer of the laminated glass, or may be provided on the surface of one of the two glass plates. The conductor 110 may be a transparent conductor layer, or may be a heater wire, a bus bar, or the like for snow removal or defrosting, formed by a metal film such as a copper film, or a sintered body of conductor paste.

In addition, as illustrated in FIG. 1D, in a case in which the roof 106 and the pillar 105 are electrically connected, and the conductor 110 is sufficiently capacitively coupled to the pillar 105, the conductor 110 and the roof 106 are indirectly electrically connected. Accordingly, even when the conductor 110 is not directly electrically connected to the roof 106, the conductor 110 may be regarded as a part of the vertical conductor. The length of the conductor 110 in the Y-direction is desirably long compared to the wavelength of the radio waves used for transmission and reception. In addition, the length of the conductor 110 in the X-direction is not limited to a particular value and may be set in a range in which the vertical polarized waves are obtainable, and is desirably short compared to the wavelength of the radio waves used for the transmission and reception.

In this embodiment, the antenna conductor 101 is provided in-plane at the upper right of the automotive windshield glass 102, however, the location of the antenna conductor 101 is not limited to that of this embodiment. The antenna conductor 101b may be provided at a symmetrical position, using as an axis of symmetry, the centerline 107 extending in the up and down directions and passing through the center of gravity of the automotive windshield glass 102.

By providing the antenna conductor in the vicinity of the connecting part between the horizontal conductor that is provided linearly in the horizontal direction and the vertical conductor that is provided linearly in the vertical direction and electrically connected to the horizontal conductor, it is possible to efficiently transmit and receive the vertical polarized waves from both the current generated in the vertical conductor due to arrival of the vertical polarized waves and the current transferred from the vertical conductor to the horizontal conductor.

FIG. 2 is a plan view of an antenna device, on an enlarged scale, for a case in which the antenna conductor 101 in FIG. 1A is arranged in the vicinity of the connecting part 109a where the roof 106 (horizontal conductor) forming the auxiliary conductor and the pillar 105 (vertical conductor) forming the side connect at a predetermined angle. In FIG. 2, the illustration of the black concealing layer 104 is omitted, in order to avoid this figure becoming too complicated. In addition, it is assumed that the pillar 105 and the roof 106 intersect perpendicularly to each other.

As illustrated in FIG. 2, the antenna conductor 101 includes a feeding point of the antenna conductor (hereinafter referred to as “feeding point”), a first element 201, and a second element 202. The feeding point includes a first feeding part 203, and a second feeding part 204.

The first element 201 has one end connected to the first feeding part 203, and includes a partial element 201a extending downwardly in FIG. 2, and a partial element 201b extending in a rightward direction from a starting point using a terminating part of the partial element 201a as the starting point. The partial element 201b extends to a terminating end A of the first element 201. In a case in which the terminating end A is provided at an intermediate point of the partial element 201a, the partial element 201b may be omitted.

In this embodiment, the length of the first element 201 is in a range greater than or equal to 0.2λ_{g} and less than or equal to 0.35λ_{g}, where the wavelength in air at the center frequency of the predetermined frequency band is denoted by λ₀, the wavelength shortening coefficient of the automotive windshield glass 102 is denoted by k, and the wavelength on the automotive windshield glass 102 is denoted by λ_{g}=λ₀·k.

For example, in a case in which the inter-vehicle communication is set as the desired frequencies, the center frequency of the inter-vehicle communication is 760 MHz. Accordingly, in order to improve the antenna gain of the inter-vehicle communication, the length of the first element 201 is desirably in a range greater than or equal to 50 mm and less than or equal to 89 mm, when the velocity of the radio wave is 3.0×10⁸ m/s and the wavelength shortening coefficient k is 0.64.

The second element 202 has one end connected to the second feeding part 204, and includes a partial element 202a extending in the rightward direction in FIG. 2, a partial element 202b extending downwardly from a starting point using a terminating part of the partial element 202a as the starting point, and a partial element 202c extending in a leftward direction from a starting point using a terminating part of the partial element 202b as the starting point. The partial element 202c extends to a terminating end B of the second element 202.

The feeding point is located at a part of the antenna conductor 101 along the roof 106, that is, at the element of the antenna conductor 101 on the side closer to the roof 106 and along the roof 106. In FIG. 2, the feeding point is provided on an extension along the roof 106, including the partial element 202a. The second feeding part 204 is arranged on the side closer to the pillar 105 than the first feeding part 203.

The first element 201 and the second element 202 are arranged so that the terminating end A at the other end of the first element 201 and the terminating end B at the other end of the second element 202 are adjacent to each other. The cutout part 205 is formed between the terminating end A and the terminating end B. Accordingly, the entire shape of the antenna conductor 101 is a semi-loop shape having the cutout part 205 at a part of the loop shape. Thereafter, in a case in which the first element 201 and the second element 202 are regarded as a single element, the first and second elements 201 and 202 in this case will be referred to as “semi-loop element”.

The partial element 201a forms a left side part of the semi-loop element, and the partial element 201b forms a part of a lower side part of the semi-loop element. On the other hand, the partial element 202a forms an upper side part of the semi-loop element to extend along the roof 106, the partial element 202b forms a right side part of the semi-loop element to extend along the pillar 105, and the partial element 202c forms a part of the lower side part of the semi-loop element.

In this embodiment, the terminating end A of the first element 201 and the terminating end B of the second element 202 exist at the same Y-coordinate, however, the locations of the terminating ends A and B are not limited to those of this embodiment. In other words, the terminating ends A and B may exist at different Y-coordinates, and the entire shape of the antenna conductor 101 may be a semi-loop shape with a stepped part. Further, the partial element 201b and the partial element 202c may be separated in the Y-direction, and overlap (hereinafter referred to as “overlapping elements”).

In a case in which a corner part of the metal flange 103 has an arcuate shape, the connecting part between the partial element 202a and the partial element 202b may have an arcuate shape matching the arcuate shape of the corner part of the metal flange 103.

Although the entire shape of the antenna conductor 101 in this embodiment has an oblong semi-loop shape, the entire shape of the antenna conductor 101 is not limited to that of this embodiment. The semi-loop element may have a parallelogram shape, a trapezoidal shape, a square shape, a circular shape, a polygon shape, or a fan-shape. Particularly, the partial element 201a and the partial element 202b may be formed parallel to or approximately parallel to the pillar 105, and the partial element 201b and the partial element 202c may be formed parallel to or approximately parallel to the roof 106.

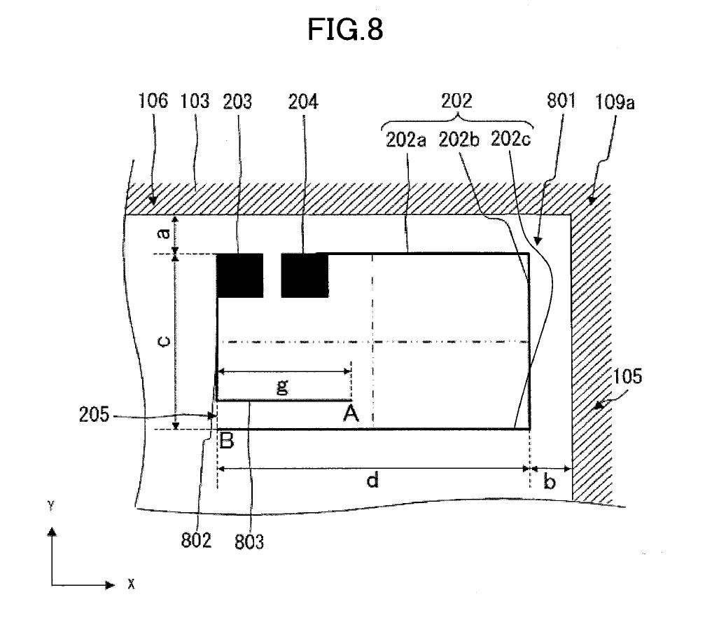

The cutout part 205 separates the terminating end A of the first element 201 and the terminating end B of the second element 202, so that there is substantially no electrical connection between the first element 201 and the second element 202. Substantially no electrical connection not only refers to a case in which there is no DC coupling, but also refers to a case in which there is no AC coupling at an operating frequency of the antenna conductor 101. For example, even when the semi-loop element is shaped as illustrated in FIG. 8 which will be described later, such that the partial element 201b and the partial element 202c are separated in the Y-direction and overlap at the cutout part 205, there is substantially no electrical connection in a case in which a length g of the overlapping part is insufficient to generate a high-frequency conduction state between the first element 201 and the second element 202. In this embodiment, the length of the overlapping part is desirably 0.06λ_{g} or less, and more preferably 0.04λ_{g} or less. For example, in the case in which the ITS having the center frequency of 760 MHz is considered, the length of the overlapping part is desirably less than 15 mm, and more preferably less than 10 mm.

The cutout part 205 is provided on a side opposite to the roof 106 with respect to a horizontal line passing through a center point e of a region surrounded by the semi-loop element, and on a side opposite to the pillar 105 with respect to a vertical line passing through the center point e. Further, the cutout part 205 is preferably provided at a position such that an angle (hereinafter referred to as “angle at which the cutout part 205 is provided”) formed by a straight line connecting the center point e and an intermediate point f of the cutout part 205 and a horizontal line parallel to the X-axis is in a range greater than or equal to 20° and less than or equal to 75°, and more preferably in a range greater than or equal to 30° and less than or equal to 65°. The angle at which the cutout part 205 is provided is furthermore preferably in a range greater than or equal to 35° and less than or equal to 60°. The center point e of the region surrounded by the semi-loop element refers to a center of gravity of the loop shape that omits the cutout part 205 of the semi-loop element. The intermediate point f of the cutout part 205 refers to a middle point of a straight line connecting the terminating end A of the first element 201 and the terminating end B of the second element 202.

In this embodiment, the cutout part 205 is provided at the lower side of the semi-loop element, however, the location of the cutout part 205 is not limited to that of this embodiment. In other words, depending on the angle at which the cutout part 205 is provided and an aspect ratio (a value obtained by dividing a height of the semi-loop element by a width of the semi-loop element) of the semi-loop element, the cutout part 205 may be provided at a position including a lower left vertex of the semi-loop element, or at a left side of the semi-loop element. A detailed description of such locations of the cutout part 205 will be given later in conjunction with a third embodiment.

A length of the cutout part 205 is not limited to a particular value as long as the first element 201 and the second element 202 make no direct connection, however, is preferably in a range of 0.1 mm to 5 mm. The length of the cutout part 205 refers to a gap at a part where the first element 201 and the second element 202 are closest to each other at the cutout part 205. In FIG. 2, the length of the cutout part 205 corresponds to a length of the straight line connecting the terminating end A of the first element 201 and the terminating end B of the second element 202.

The first feeding part 203 and the second feeding part 204 are parts for electrically connecting the antenna conductor 101 to a signal processing circuit that is not illustrated, such as an amplifier or the like, via a predetermined conductive member. For example, a feeder line, such as a coaxial cable or the like, may be used as the conductive member. In a case in which the coaxial cable is used, an inner conductor of the coaxial cable is electrically connected to one of the first feeding part 203 and the second feeding part 204, and an outer conductor part of the coaxial cable is electrically connected to the other of the first feeding part 203 and the second feeding part 204. In addition, a configuration may be employed in which a connector for electrically connecting the signal processing circuit, such as the amplifier or the like, to the feeding point is mounted at the feeding point. The coaxial cable can be mounted on the feeding point with ease using such a connector. Moreover, a configuration may be employed in which a conductive member having a projection shape is provided at the feeding point, and the conductive member having the projection shape makes contact with and/or is fitted into the connecting part that is provided on the metal flange 103 of the vehicle mounted with the automotive windshield glass 102. A part of or the entire feeding point may be provided in a peripheral region that includes the black concealing layer 104.

The first feeding part 203 and the second feeding part 204 are arranged adjacent to each other. The first feeding part 203 is provided in a vicinity of an upper left corner part of the antenna conductor 101 in FIG. 2. As described above, because the length of the first element 201 and the angle at which the cutout part 205 is provided fall within predetermined ranges, respectively, the position of the first feeding part 203 is consequently determined by the length of the first element 201 and the angle at which the cutout part 205 is provided. A more detailed description of such determination of the position of the feeding part 203 will be given later in conjunction with a second embodiment.

In a case in which a height of the semi-loop element in the vertical direction is denoted by c, and a width of the semi-loop element in the horizontal direction is denoted by d, a sufficient reception rate can be obtained when the aspect ratio (c/d) that is obtained by dividing the height c by the width d of the semi-loop element is greater than or equal to 0.3. When the aspect ratio becomes less than 0.3, the lower side of the semi-loop element becomes adjacent to the first feeding part 203 or the second feeding part 204 or both, and it is not preferable in that a capacitive coupling may occur and the semi-loop element may be affected from the feeding point.

From a viewpoint of improving the transmitting and receiving performance, a circumference of the semi-loop element is desirably in a range of 1.05λ_{g} to 1.5λ_{g}, by assuming the semi-loop element to have an original loop shape having no gap between the first feeding part 203 and the second feeding part of the feeding point and no cutout part 205. In the following description, “circumference of the semi-loop element” refers to an outer peripheral length of the semi-loop element by assuming the semi-loop element to have the original loop shape having no gap between the first feeding part 203 and the second feeding part 204 of the feeding point and no cutout part 205.

According to the antenna device described above, the gain is high with respect to a vehicle front direction of the vertical polarized waves, and the roof-feeding is possible, to enable the feeding point to be designed with a high degree of freedom.

The antenna conductor, the feeding point, and the conductor may be formed by printing a paste including a conductive metal, such as silver paste or the like, on an inner surface of the automotive windshield glass 102 on the inner side of the vehicle, for example, and baking the printed paste. However, the method of forming the antenna conductor, the feeding point, and the conductor is not limited to printing and baking the paste. For example, a wire-shaped member of a film-shaped member made of a conductive material, such as copper or the like, may be formed on the outer surface of the automotive windshield glass 102, bonded on the automotive windshield glass 102 by an adhesive or the like, or provided inside the automotive windshield glass 102 itself. In addition, a conductor layer including the antenna conductor may be provided inside or on a surface of a synthetic resin film, and this synthetic resin film including the conductor layer may be formed on the inner surface or the outer surface of the automotive windshield glass 102 to form the antenna conductor. Furthermore, a flexible printed circuit including the antenna conductor may be provided on the inner surface of the automotive windshield glass 102 to form the antenna conductor.

The shape of the feeding point may be determined according to the shape of the conductive member or a mounting surface of the connector. For example, from a practical viewpoint, the shape of the feeding point is preferably rectangular, including a square shape, an approximate square shape, a rectangular shape, an approximately rectangular shape, or the like, or a polygonal shape. The shape of the feeding point may also be circular, including a circular shape, an approximately circular shape, an oval shape, an approximately oval shape, or the like.

The automotive windshield glass 102 is not limited to glass plates, and may include a light transmission member such as a transparent resin plate, and a composite body of one or more glass plates and one or more transparent resin plates.

In this embodiment, the antenna conductor 101 is provided at only one location of the automotive windshield glass 102. However, the antenna conductor 101 may be provided at a plurality of locations on the same windshield glass, or provided on a plurality of windshield glass, to use the plurality of antenna conductors 101 for diversity reception. The receiving sensitivity can further be improved by performing the diversity reception.

### Second Embodiment

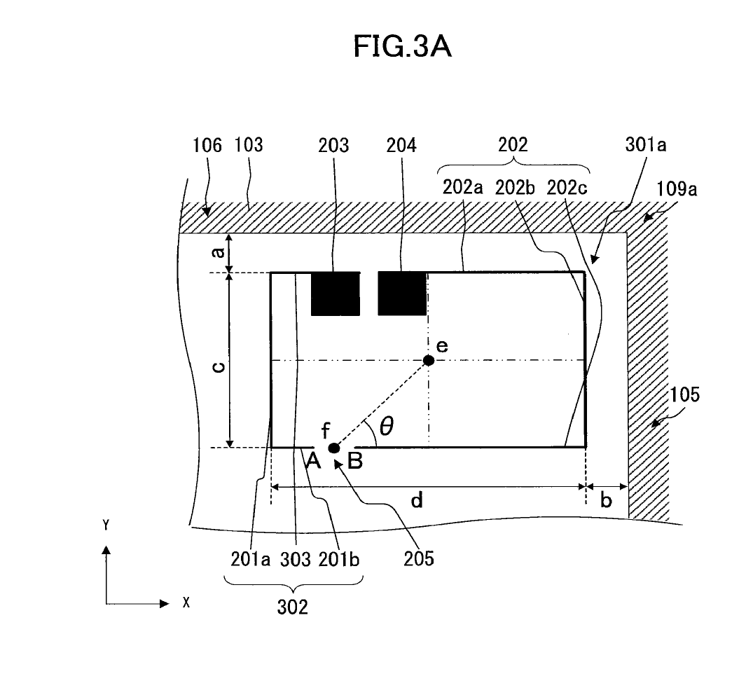

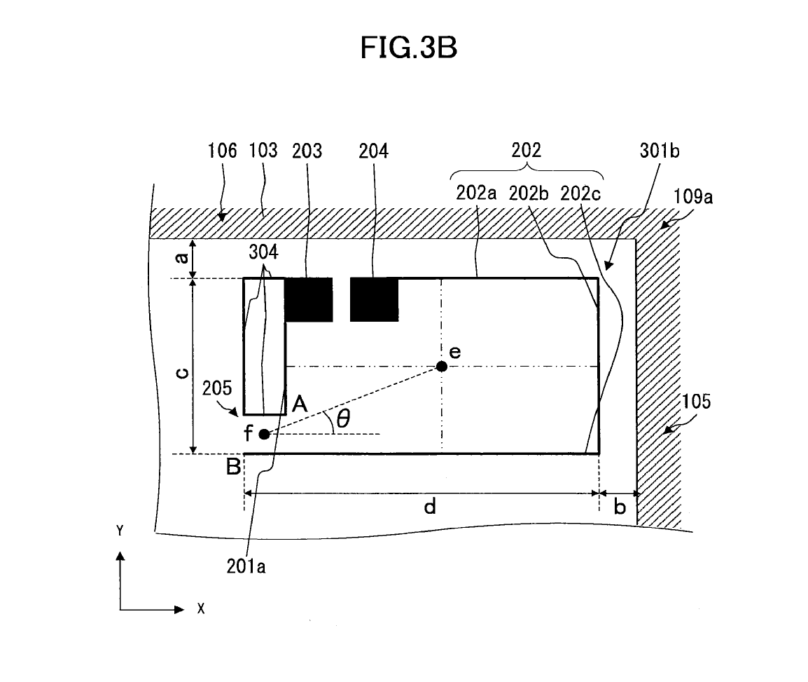

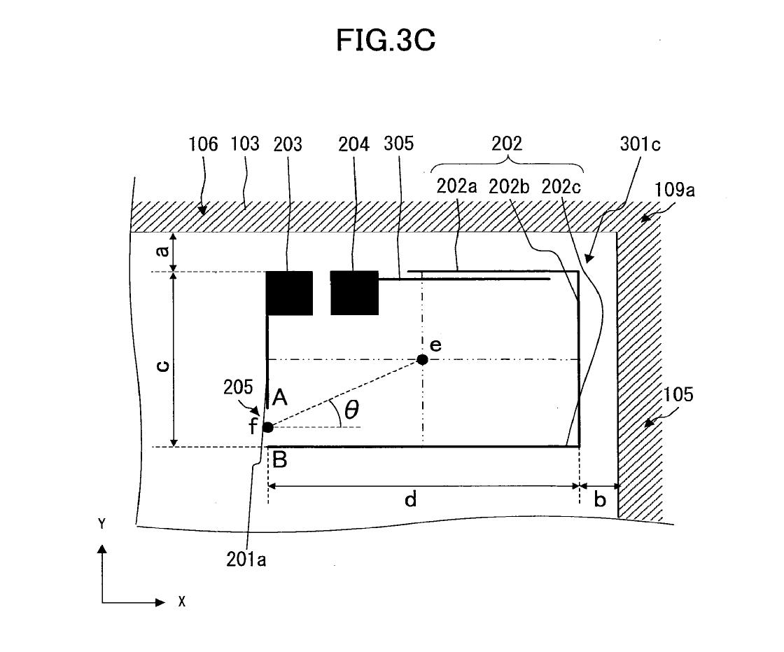

The antenna conductor 301a of the antenna device in the second embodiment is a variation of the antenna conductor 101 in the first embodiment, as illustrated in FIG. 3A. In this second embodiment, a first element 302 differs from that of the first embodiment, however, other parts are the same as the first embodiment. For this reason, the same constituent parts are designated by the same reference numerals, and a description thereof will be omitted. In order to give a description for a case in which the arrangement and position are as illustrated in FIG. 1A, the distance from the horizontal conductor is referred to as the distance from the roof, and the distance from the vertical conductor is referred to as the distance from the pillar.

In the second embodiment, the length of the first element 302 is extended and the position of the feeding point is different as compared to the first embodiment, without changing the distance from the roof 106 and the distance from the pillar 105 of the antenna conductor 101, the angle at which the cutout part 205 is provided, the aspect ratio of the semi-loop element, and the entire length of the semi-loop element.

In the second embodiment, the partial element 201a is not directly connected to the first feeding part 203, and is connected to the first feeding part 203 via a first attached element 303. In this case, a combination of the first attached element 303, the partial element 201a, and the partial element 201b forms the first element 302, and the length of the first element 302 is a sum of the lengths of the first attached element 303, the partial element 201a, and the partial element 201b. As described above, the length of the first element 302 and the angle at which the cutout part 205 is provided fall within the predetermined ranges, respectively, and the position of the first feeding part 203 is not limited to the upper left corner part illustrated in FIG. 3A, depending on the length and the angle falling within the respective predetermined ranges. However, in this example, the first feeding part 203 is provided at the upper side of the antenna conductor 301a in order to enable the roof-feeding. Even in a case in which the length of the first element 201 is the shortest, the position of the first feeding part 203 is assumed to be at the upper left corner part where the left side and the upper side of the first element 302 connect.

In the second embodiment which is a variation of the first embodiment, it is possible to obtain a satisfactory transmitting and receiving performance, and the roof-feeding is possible, to enable the feeding point to be designed with a high degree of freedom, similarly as in the case of the first embodiment.

Further, examples of other attached elements are illustrated in FIGS. 3B and 3C.

In FIG. 3B, the first element 201 includes only the partial element 201a, and a loop forming element 304 forming a loop with the first feeding part 203 and the partial element 201a is provided.

Accordingly, by forming one of the sides of the semi-loop element into a loop, an even higher receiving sensitivity can be obtained. In this specification, “forming a loop” is not limited to forming a closed loop, and includes forming an incomplete loop shape, such as a U-shape or the like, in which one of the sides is not closed.

In the example illustrated in FIG. 3B, the loop forming element 304 is formed on the outer side of the partial element 201a, and the loop is formed on the outer side of one side of the antenna conductor 301b. However, the loop is not limited to this arrangement, and the loop may be formed on the inner side of one side of the antenna conductor 301b.

In FIG. 3B, the partial element 202C extends exceeding the X-coordinate position of the terminating end A of the first element 201. However, the terminating end B of the second element 202 may be provided at the X-coordinate position that is the same as that of the terminating end A of the first element 201.

In FIG. 3C, the overlap forming element 305 is connected to the second feeding part 204 and extends along the partial element 202a. The partial element 202a does not connect directly to the second feeding part 204, and is capacitively coupled to the overlap forming element 305 at the overlapping part. By forming the overlapping part in one of the sides of the semi-loop element at a part other than the cutout part 205, and arranging the elements adjacent to each other to form the capacitive coupling, it becomes possible to improve an impedance matching with the cable that supplies power to the antenna conductor 301c, and obtain an even higher receiving sensitivity. Hence, the overlap forming element 305 has one end thereof connected to the second feeding part 204 (or the first feeding part 203), and a part thereof extending along one side of the semi-loop element, to form the overlapping part.

### Third Embodiment

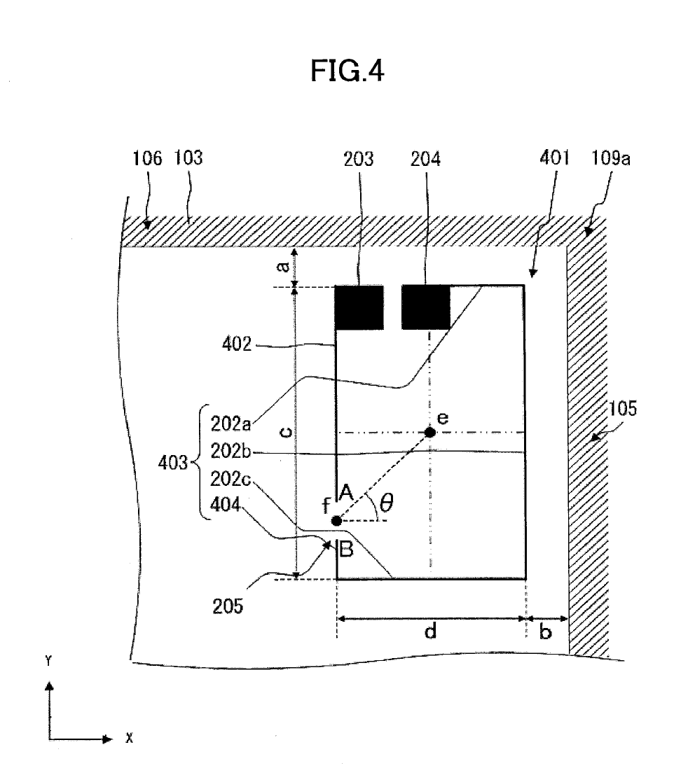

The antenna conductor 401 of the antenna device in the third embodiment is a variation of the antenna conductor 101 in the first embodiment, as illustrated in FIG. 4. In this third embodiment, a first element 402 and a second element 403 differ from those of the first embodiment, however, other parts are the same as the first embodiment. For this reason, the same constituent parts are designated by the same reference numerals, and a description thereof will be omitted.

In the third embodiment, the aspect ratio of the semi-loop element is changed, without changing the distance from the roof 106 and the distance from the pillar 105 of the antenna conductor 101, the angle at which the cutout part 205 is provided, the entire length of the semi-loop element, the position of the feeding point, and the length of the first element 401.

Unlike the first embodiment, the first element 402 does not include the partial element 201a and the partial element 201b. The partial element 201b may be omitted depending on the aspect ratio of the semi-loop element and the angle at which the cutout part 205 is provided.

In addition, the second element 403 includes a partial element 404 that extends upwards from the terminating end part of the partial element 202c. Such a partial element 404 may be provided depending on the angle at which the cutout part 205 is provided.

In the third embodiment, the terminating end A of the first element 402 and the terminating end B of the second element 403 exist at the same X-coordinate position, however, the positions of the terminating ends A and B are not limited to those of this embodiment. In other words, the terminating end A and the terminating end B may exist at different X-coordinate positions, and the entire antenna conductor may form a semi-loop element with a stepped part.

In the third embodiment which is a variation of the first embodiment, it is possible to obtain a satisfactory transmitting and receiving performance, and the roof-feeding is possible, to enable the feeding point to be designed with a high degree of freedom, similarly as in the case of the first embodiment.

<Description of Principle>

Next, a description will be given of a transmitting and receiving principle of the inter-vehicle communication in one embodiment of the present invention. Due to reciprocity of the transmitting principle and the receiving principle via the antenna, a description will be given of the reception, via the antenna, of the radio waves transmitted from the vehicle of the other party. In addition, although it is assumed in the following that the roof 106 forms the horizontal conductor and the pillar 105 forms the vertical conductor, the transmitting and receiving principle is the same for a case in which the conductor 108h forms the horizontal conductor and the conductors 108v and 110 form the vertical conductor.

The vertical polarized waves transmitted from the vehicle of the other party in the inter-vehicle communication reach the pillar 105 of the vehicle body. The pillar 105 of the vehicle body has a predetermined inclination with respect to the horizontal line, and has a width that is narrow compared to the wavelength of the vertical polarized waves. In addition, a length of the pillar 105 is long. Hence, the pillar 105 may be regarded as an antenna conductor in which a current of opposite phase is generated approximately at half-wavelength intervals. In the case in which the radio waves reach the vehicle body from the vehicle front direction, the plurality of currents generated in the pillar 105 by the received radio waves are in a mutually intensifying relationship. Furthermore, the currents generated in the pillar 105 propagate to the roof 106. When the antenna conductor 101 is arranged in the vicinity of a connecting part between the pillar 105 and the roof 106 as in this embodiment, the currents generated in the pillar 105 and the currents propagated to the roof 106 can both be received efficiently. As a result, it is possible to obtain a high receiving sensitivity with respect to the vertical polarized waves.

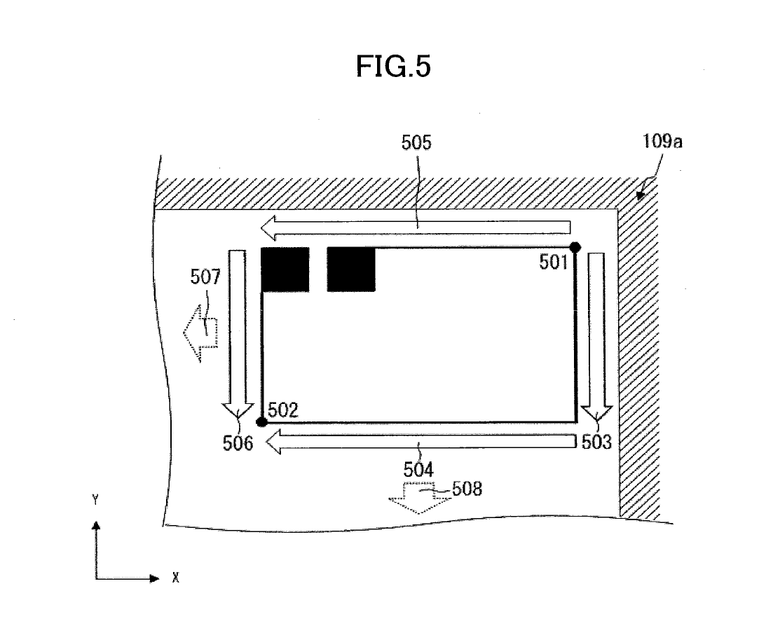

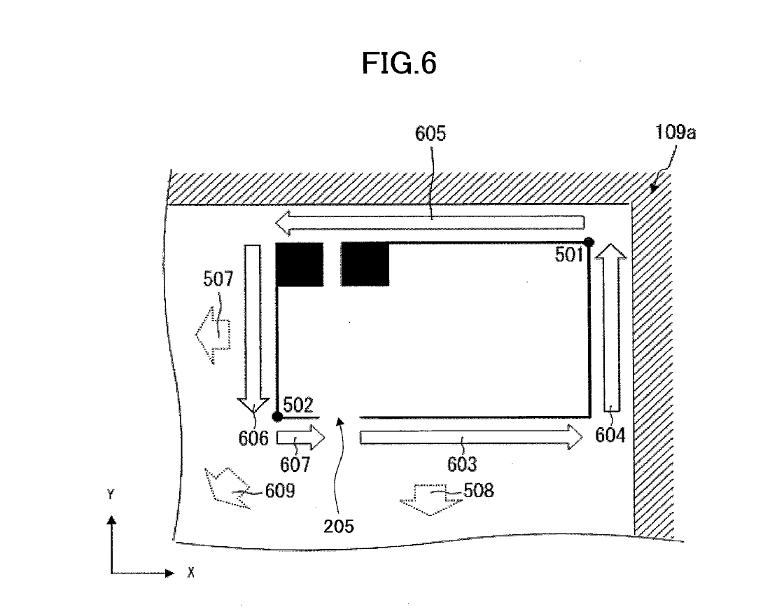

Next, a description will be given of the significance of providing the cutout part 205 in the first embodiment, by referring to FIGS. 5 and 6. Antenna patterns illustrated in FIGS. 5 and 6 are the same as the antenna pattern of the first embodiment, and the same parts are designated by the same reference numerals. In addition, due to reciprocity of the transmitting principle and the receiving principle via the antenna, a description will be given of the transmission of information via the antenna, using the current flow.

As illustrated in FIG. 5, in the case of a loop antenna having no cutout part 205, two currents flowing in opposite directions, namely, a current flowing in a direction of an arrow 503 to a direction of an arrow 504, and a current flowing in a direction of an arrow 505 to a direction of an arrow 506, are generated on the antenna conductor. Because the loop antenna has a property to maintain balance, the two currents behave as a standing wave. In this state, current nodes exist in which a current always does not flow, such as points 501 and 502, and for this reason, electric field radiating directions are always fixed to directions of an arrow 507 and an arrow 508. As a result, an angle is generated at which the gain is uneasily obtained by the other party receiving the radio waves.

On the other hand, as illustrated in FIG. 6, in the case of the semi-loop element having the cutout part 205, the balance is not maintained due to the provision of the cutout part 205. In this case, the current flows using the cutout part 205 as a starting point, in a direction from an arrow 603 to directions of an arrow 604, an arrow 605, an arrow 606, and an arrow 607, to circulate on the antenna conductor. In this state, the current also flows at the point 501, the current does not behave as a standing wave, and the electric field radiating directions are not fixed. In other words, the electric field is not only radiated in the directions of the arrow 507 and the arrow 508, but also in the direction of the arrow 609 or the like. Hence, the electric field is radiated over a wider range, and the angle at which the gain is uneasily obtained by the other party receiving the radio waves is unlikely generated.

Exemplary Implementations

<Measurement of Antenna Directivity>

An automotive front windshield glass with an antenna, having an antenna conductor provided on the automotive front windshield glass, is mounted on an actual automobile. A description will be given of measurement results of an antenna gain for this automotive front windshield glass with the antenna.

The antenna gain is measured in a state in which the automotive front windshield glass with the antenna is mounted on a window frame of the automobile that is set on a turntable, at an inclination of “approximately 23°” with respect to a horizontal plane. A connector is mounted on the feeding point, and the feeding point is connected to a network analyzer via a feeder line. The turntable rotates so that radio waves are irradiated in a horizontal direction from all directions with respect to the automotive front windshield glass with the antenna.

The antenna directivity is measured by setting a vehicle center of the automobile mounted with the automotive front windshield glass with the antenna conductor 101, at a center of the turntable, and rotating the automobile by 360°. Data of the antenna directivity are represented by values of the antenna gain of the vertical polarized waves measured for every rotary angle of 1° at each frequency during the 360° rotation. The measurement is performed in a state in which an elevation angle of a radio wave transmitting position and the antenna conductor is approximately the horizontal direction (direction in which the elevation angle=0°, in a case in which the elevation angle=0° for a plane parallel to the ground surface, and the elevation angle=90° for a zenith direction). The antenna gain is standardized and computed in dBi so that, with respect to a measured value of a relative gain with respect to a half-wave dipole antenna, the antenna gain is 0 dB for an isotropic antenna. When measuring the directivity, the antenna is provided with the arrangement and position of FIG. 1A, and thus, the distance from the roof 106 is regarded as the distance from the horizontal conductor, and the distance from the pillar 105 is regarded as the distance from the vertical conductor.

<Change in Directivity Depending on Existence of Cutout Part 205>

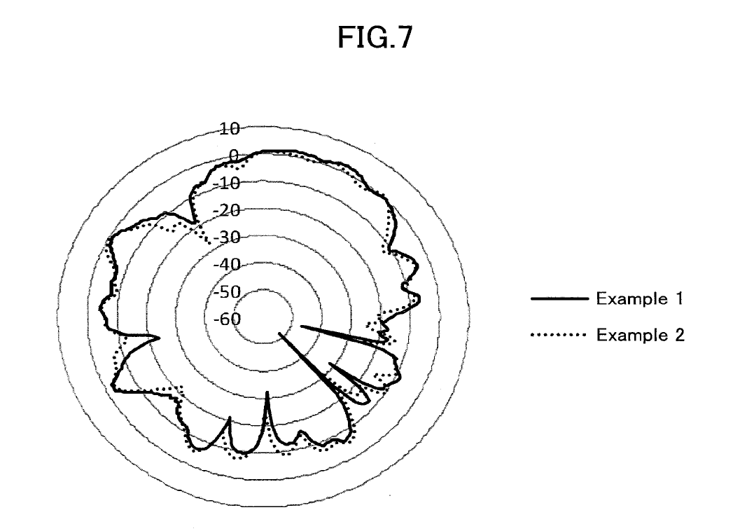

The directivity is measured for the automotive front windshield glass with the antenna conductor 101 illustrated in FIG. 2 and having the cutout part 205 (referred to as Example 1 in FIG. 7), and the automotive front windshield glass with the loop antenna having the terminating end A and the terminating end B of the antenna conductor 101 that are connected and having no cutout part 205 (referred to as Example 2 in FIG. 7). FIG. 7 illustrates a result of comparing the measured directivities. Dimensions (in units of mm) of each part of the antenna conductor 101 used for the measurement to obtain the results of FIG. 7 are as follows.

Distance b from pillar 105: 10

Distance a from roof 106: 15

Circumference of semi-loop element: 300

Length of first element: 53

Vertical sides of first feeding part 203 and second feeding part 204: 15

Horizontal sides of first feeding part 203 and second feeding part 204: 17.5

Distance between first feeding part 203 and second feeding part 204: 5

Length of cutout part 205: 2

In addition, the angle at which the cutout part 205 is provided is 40 degrees, and the aspect ratio of the semi-loop element is 0.875.

In the case of the Example 2, the measurement is performed for the case in which no cutout part 205 is provided. The sizes of and the distance between the first feeding part 203 and the second feeding part 204, and the length of the cutout part 205 are the same for all of the exemplary implementations described in the following.

As illustrated in FIG. 7, by providing the cutout part 205, it is confirmed that, the Example 2 indicated by a bold solid line has an improved gain of the vertical polarized wave in the 45 degree direction, when compared to the Example 1 indicated by a dotted line. As described above in conjunction with the principle, the gain is improved because the current flows in a circulating manner and the electric field radiating directions are not fixed, such that the angle at which the gain is uneasily obtained is unlikely generated.

<Change in Directivity Depending on Existence of Overlapping Part 803>

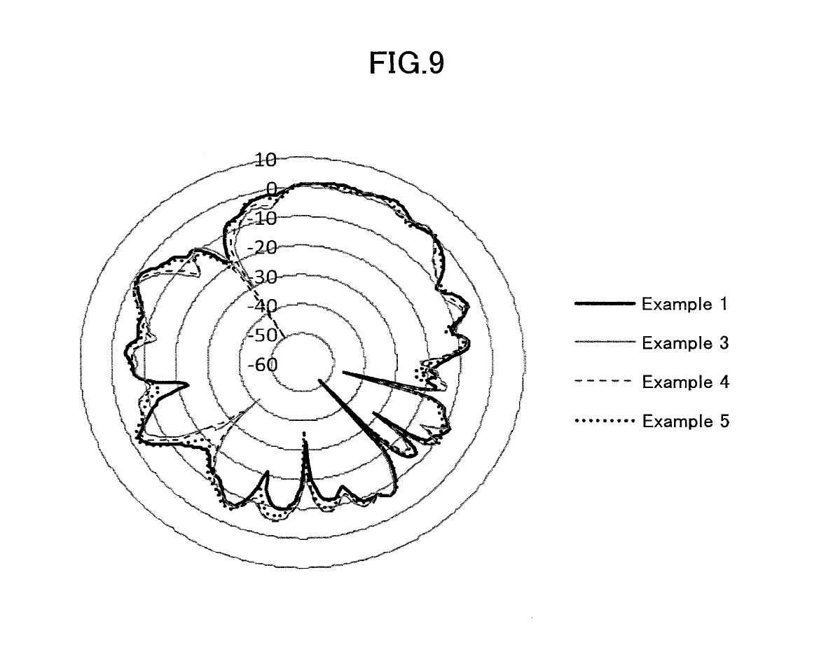

In the antenna conductor 801 of the semi-loop element configured to include the stepped part as illustrated in FIG. 8, the positions of the terminating end A and the terminating end B are adjusted to adjust the length g of the overlapping part 803, and the directivities for the adjusted cases are measured and compared. The measurement is performed for 3 kinds of lengths g of the overlapping part 803, namely, 50 mm, 30 mm, and 10 mm. Results of the measurement are illustrated in FIG. 9 as an Example 3, an Example 4, and an Example 5. Dimensions (in units of mm) of each part of the glass antenna conductor 101 used for the measurement to obtain the results of FIG. 9 are as follows.

Distance b from pillar 105: 10

Distance a from roof 106: 15

Circumference of semi-loop element: 300

Length of first element 802: 50

Length g of overlapping part 803: 10, 30, 50

In addition, the angle at which the cutout part 205 is provided is 40 degrees, and the aspect ratio of the semi-loop element is 0.875.

From the results of FIG. 9, it is confirmed that the gain of the vertical polarized wave in the 45 degree direction decreases when the overlapping part 803 is provided, even when the cutout part 205 is provided, in the case of each of the Example 3 indicated by a thin solid line, the Example 4 indicated by a broken line, and the Example 5 indicated by a dotted line, as compared to the Example 1 indicated by the bold solid line. The gain decreases by providing the overlapping part 803, because the currents having mutually opposite phases cancel each other in the overlapping part 803. Further, in a case in which the length g of the overlapping part 803 is long as in the case of the Example 3, the capacitance of the cutout part 205 increases and the capacitive coupling occurs. Consequently, it may be regarded that the current behaves in a manner similar to that of the loop element having no cutout part 205, and the current no longer circulates, to thereby generate the angle at which the gain is uneasily obtained. Accordingly, it is preferable not to form the overlapping part 803. However, in a case in which the overlapping part 803 is less than 10 mm in length, it may be regarded that there is substantially no electrical connection at the operating frequency of the antenna conductor 101, and the length of less than 10 mm may be tolerated.

<Ray Tracing Simulation>

Next, a description will be given of the satisfactory communication performance obtainable by the antenna device in one embodiment of the present invention, not only with the antenna device in one embodiment but also with a roof-top antenna, by referring to results of ray tracing simulation.

In the embodiment described hereunder, it is assumed that the present invention is applied to the antenna for the inter-vehicle communication, and such antennas are used for the communication to notify positions of each other at an intersection having a poor view.

FIG. 10 is a diagram of an analyzing model of a vicinity of an intersection that is set on the ray tracing simulation. The analyzing model is configured to include 2 connecting roads 1002 and 1003 intersecting perpendicularly at an intersection 1001, and structures 1004, 1005, 1006, and 1007 at four locations other than the connecting roads 1002 and 1003. A number of reflections of the radio waves is set to 10 times at a maximum, and a number of diffractions of the radio waves is set to 1 time. Reflecting surfaces of the radio waves are limited to wall surfaces of the structures 1004, 1005, 1006, and 1007 and the ground surface. It is assumed that the structures 1004, 1005, 1006, and 1007 have a height that is infinitely high, and that no diffraction occurs at the roof.

A transmitting point 1008 of the radio waves is set on the side of the connecting road 1002 that intersects at the intersection 1001, and a receiving point 1009 is set on the side of the connecting road 1003 that intersects at the intersection 1001. A distance from a current location of the transmitting point 1008 to an entrance (connecting part between the intersection 1001 and the connecting road 1002) on the side of the connecting road 1002 of the intersection 1001 is referred to as an approach distance dt of the transmitting point 1008. On the other hand, a distance from an entrance (connecting part between the intersection 1001 and the connecting road 1003) on the side of the connecting road 1003 of the intersection 1001 to the receiving point 1009 is referred to as a distance dr, where dt<dr. A near end of the intersection 1001 is regarded as transmitting, and a far end from the intersection is regarded as receiving.

The transmitting point 1008 set on the connecting road 1002 assumes the existing location of the automobile mounted with the antenna transmitting the radio waves. The receiving point 1009 set on the connecting road 1003 assumes the existing location of the other communicating party (for example, another vehicle) receiving the radio waves transmitted from the transmitting point 1008 (antenna of the automobile). A propagation loss between the transmitting point 1008 and the receiving point 1009 can be obtained by complex synthesis of a transfer function of a path that is generated.

Other parameters of the ray tracing simulation include a frequency of the radio waves transmitted and received between the transmitting point 1008 and the receiving point 1009 that is set to 720 MHz, an antenna height of the transmitting point 1008 and the receiving point 1009 that is set to 1.3 m, a material of the structures 1004, 1005, 1006, and 1007 that is set to concrete (specific permittivity of 6.77 and a conductivity of 0.023), a specific permittivity of the ground surface that is set to 3.0, and the conductivity of the ground surface that is set to 0.0001.

When a plurality of structures exist in the propagation path as illustrated in FIG. 10, multipath phasing occurs, and the propagation loss greatly varies depending on a lane or position of each of the automobile and the other communicating party on each connecting road.

Accordingly, a “reception rate P” is introduced as an index for uniquely evaluating the propagation characteristic that varies according to a road width wt of the connecting road 1002, a road width wr of the connecting road 1003, and the distances dt and dr from the intersection 1001.

First, in order to define the reception rate P, M transmitting points 1008 are set on the connecting road 1002 in the direction of the road width wt, and N receiving points 1009 are set on the connecting road 1003 in the direction of the road width wr. Hence, (M×N) combinations of the propagation characteristic data between the transmitting and receiving points are obtained by combining each of the M transmitting points 1008 and the N receiving points 1009. The “reception rate P” is defined as a value that is obtained by dividing a number of propagation characteristic data having a loss smaller than a predetermined threshold value th, by a total number (=M×N) of propagation characteristic data. In other words, the smaller the propagation loss and the more satisfactory the communication performance of the transmitting and receiving condition, the higher the value of the reception rate P.

In order to simulate the reception rate P, the ray tracing simulation set the transmitting point 1008 from a road width center position of the connecting road 1002 to a position separated by 1.5 m on the side of the structure 1006, at 4 positions at 50 cm intervals. In addition, the ray tracing simulation set the receiving point 1009 from a road width center position of the connecting road 1003 to the structure 1007 at 10 cm intervals. Furthermore, in a case in which the receiving point 1009 is the other vehicle, the distance dr may be set greater than or equal to a distance that is required to stop the other vehicle while traveling at a speed that is 10 km/h faster than a legal speed limit with respect to the intersection 1001, by braking in response to receiving a signal from the automobile. In this embodiment, the legal speed limit for the connecting road 1003 is set to 60 km/h, the traveling speed of the other vehicle is set to 70 km/h, and the distance required to stop the other vehicle by braking is set to approximately 80 m. Hence, the distance dr is fixed to 90 m by adding a margin of 10 m to the distance required to stop the other vehicle.

In the ray tracing simulation, the road widths wt and wr, and the approach distance dt are varied to simulate the reception rate P. More particularly, the road width wt is varied from 4 m to 12 m at 2 m intervals to provide 5 kinds of road widths wt, the road width wr is varied from 4 m to 30 m at 2 m intervals to provide 14 kinds of road widths wr, and the approach distance dt is varied from 9 m to 11 m at 1 m intervals to provide 3 kinds of approach distances dt. In addition, the reception rate P is obtained from an average value of the reception rates computed for each of the approach distances dt.

Moreover, 3 cases are assumed for the patterns of the inter-vehicle communication. Case 1 refers to an example in which the transmitting point 1008 and the receiving point 1009 both use the antenna device in this embodiment, Case 2 refers to an example in which the transmitting point 1008 uses the antenna device in this embodiment and the receiving point 1009 uses an antenna device having a characteristic corresponding to that of a roof-top antenna, and Case 3 refers to an example in which the transmitting point 1008 uses the antenna device having the characteristic corresponding to that of the roof-top antenna and the receiving point 1009 uses the antenna device in this embodiment. The reception rate for the Case 1 not only considers the vertical polarized waves but also horizontal polarized waves. The characteristic corresponding to that of the roof-top antenna has a gain of 0 dBi for the vertical polarized waves and is non-directional, and a gain of −(infinity) dBi for the horizontal polarized waves, and it is assumed that the communication is not possible using the horizontal polarized waves. In addition, because the simulation is performed by providing the antenna device with the arrangement and position of FIG. 1A, the distance from the roof 106 is regarded as the distance from the horizontal conductor, and the distance from the pillar 105 is regarded as the distance form the vertical conductor.

<Angle at which Cutout Part 205 is Provided>

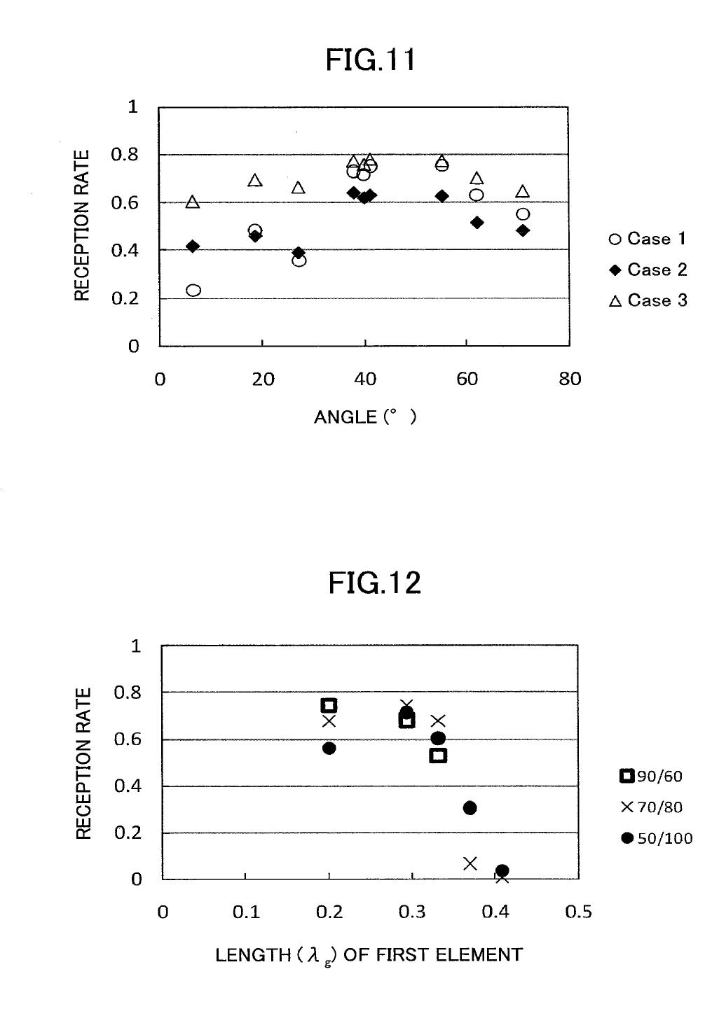

In the antenna conductor 101 illustrated in FIG. 2, the length of the first element and the aspect ratio of the semi-loop element are changed, without changing the distance from the pillar 105 and the distance from the roof 106 of the antenna conductor 101, the position of the first feeding part 203, the position of the second feeding part 204, and the circumference of the semi-loop element, to study the effects of the angle at which the cutout part 205 is provided with respect to the reception rate. Results of computing the reception rate for each of the cases are illustrated in FIG. 11.

The length of each element of the antenna conductor 101, the dimensions and the set positions of each of the parts used for the computation to obtain the results of FIG. 11 are as follows, where the dimensions are in units of mm.

Distance b from pillar 105: 10

Distance a from roof 106: 15

Circumference of semi-loop element: 300

In addition, the position of the first feeding part 203 is fixed to the upper left corner part of the semi-loop element. The aspect ratio of the semi-loop element is varied to 3 kinds of values c/d, namely, 90 mm/60 mm, 70 mm/80 mm, and 50 mm/100 mm. The length of the first element 201 is varied to 3 kinds if values, namely, 33 mm, 53 mm, and 73 mm.

As illustrated in FIG. 11, in all of Case 1, Case 2, and Case 3, desirable characteristics are obtained when the angle at which the cutout part 205 is provided is in a range greater than or equal to 20° and less than or equal to 75°.

<Length of First Element 201>

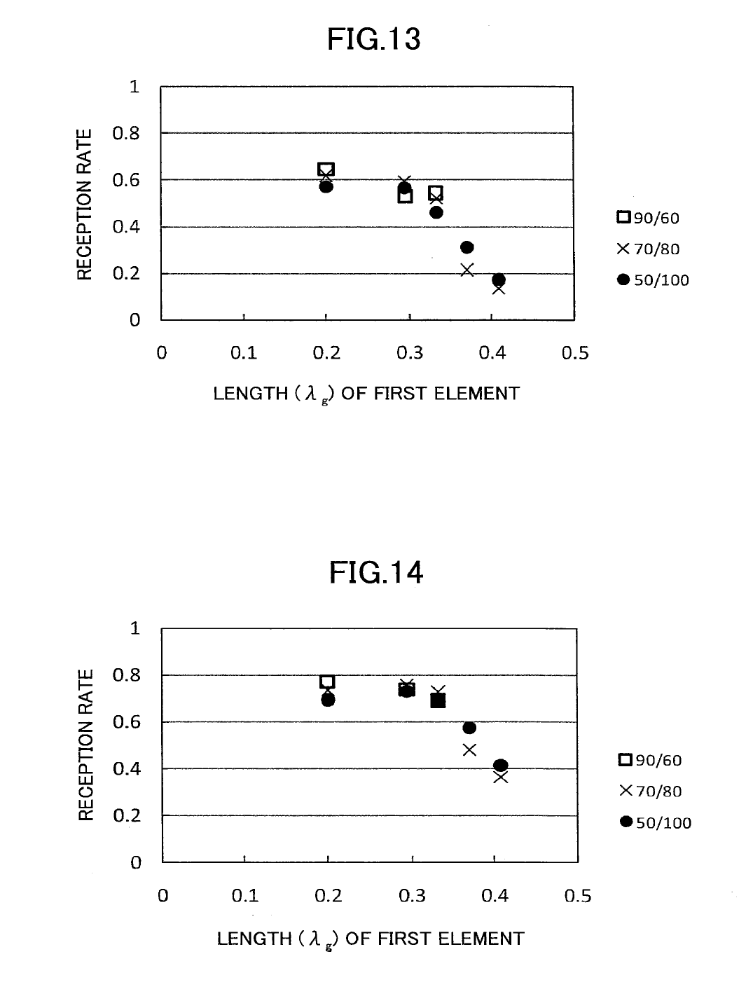

In the antenna conductor 101 illustrated in FIG. 2, the length of the first element 201 and the aspect ratio of the semi-loop element are changed, without changing the distance from the pillar 105 and the distance from the roof 106 of the antenna conductor 101, the angle at which the cutout part 205 is provided, and the circumference of the semi-loop element, to study the effects of the length of the first element 201 with respect to the reception rate. Results of computing the reception rate for each of Case 1, Case 2, and Case 3 are illustrated in FIGS. 12, 13, and 14, respectively.

The length of each element of the antenna conductor 101, the dimensions and the set positions of each of the parts used for the computation to obtain the results of FIGS. 12, 13, and 14 are as follows, where the dimensions are in units of mm.

Distance b from pillar 105: 10

Distance a from roof 1006: 15

Circumference of semi-loop element: 300

In addition, the angle at which the cutout part 205 is provided is fixed to 40 degrees. The aspect ratio of the semi-loop element is varied to 3 kinds of values c/d, namely, 90 mm/60 mm, 70 mm/80 mm, and 50 mm/100 mm (mm is omitted in the legends in the figures). The length of the first element 201 is varied to 5 kinds if values, namely, 53 mm, 78 mm, 88 mm, 98 mm, and 108 mm.

As illustrated in FIGS. 12, 13, and 14, in all of Case 1, Case 2, and Case 3, desirable characteristics are obtained when the length of the first element 201 is in a range greater than or equal to 0.2λ_{g} and less than or equal to 0.35λ_{g}. In a case in which the ITS having the center frequency of 760 MHz is considered, the length of the first element 201 is preferably in a range greater than or equal to 50 mm and less than or equal to 90 mm. The first feeding part 203 is provided at the left corner part of the semi-loop element when the length is 0.2λ_{g}, and this length is set as a minimum value for the first element in order to enable the supply of power from the roof 106.

<Setting Position of Antenna Conductor 101>

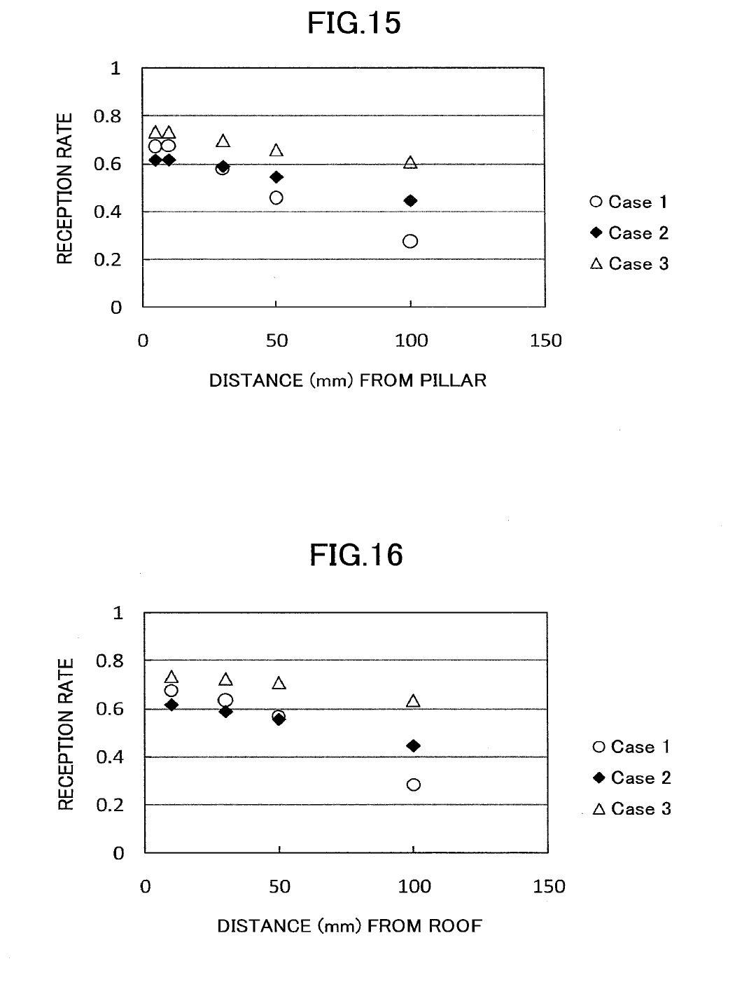

In the antenna conductor 101 illustrated in FIG. 2, the distance from the pillar 105 and the distance from the roof 106 of the antenna conductor 101 are changed, without changing the angle at which the cutout part 205 is provided, the circumference of the semi-loop element, the aspect ratio of the semi-loop element, and the length of the first element 201, to study the effects of the distances from the pillar and the roof with respect to the reception rate. Results of computing the reception rate for each of Case 1, Case 2, and Case 3 are illustrated in FIGS. 15 and 16.

The length of each element of the antenna conductor 101, the dimensions and the set positions of each of the parts used for the computation to obtain the results of FIGS. 15 and 16 are as follows, where the dimensions are in units of mm.

Circumference of semi-loop element: 300

Aspect ratio of semi-loop element: 70/80

Length of first element 201: 53

In addition, the angle at which the cutout part 205 is provided is fixed to 40 degrees.

As illustrated in FIG. 15, in all of Case 1, Case 2, and Case 3, desirable characteristics are obtained when the distance from the pillar 105 is 50 mm or less.

As illustrated in FIG. 16, in all of Case 1, Case 2, and Case 3, desirable characteristics are obtained when the distance from the roof 106 is 70 mm or less.

<Aspect Ratio of Semi-Loop Element>

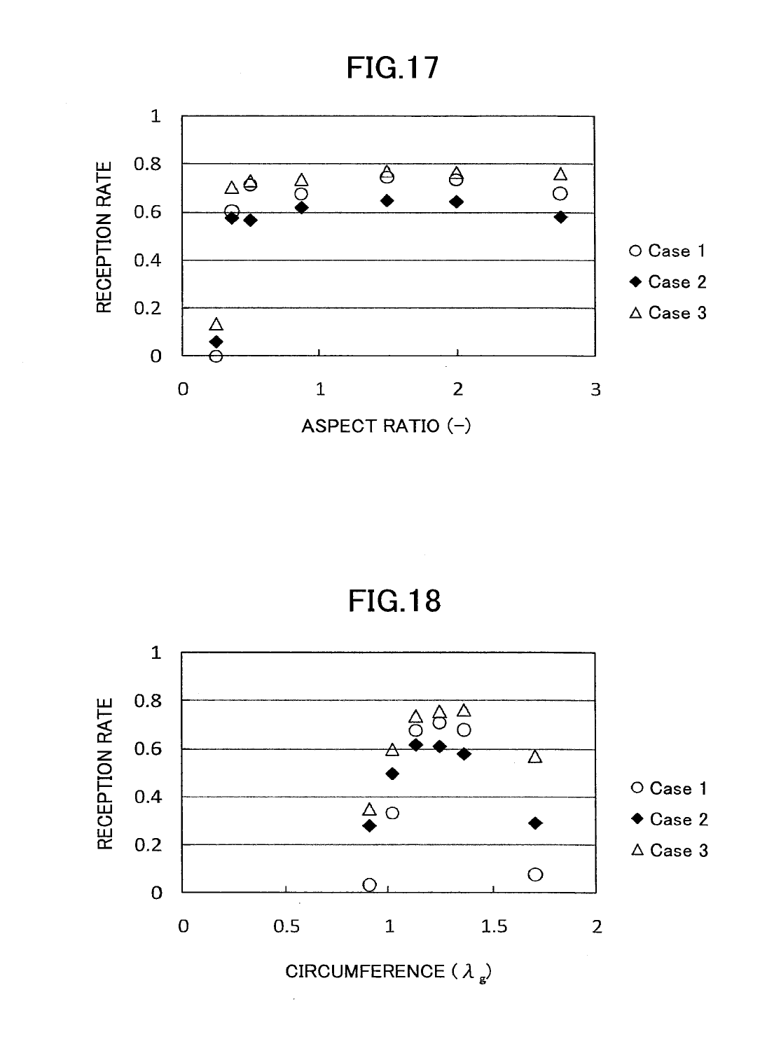

In the antenna conductor 101 illustrated in FIG. 2, only the aspect ratio of the semi-loop element is changed, without changing the distance from the pillar 105 and the distance from the roof 106 of the antenna conductor 101, the circumference of the semi-loop element, the length of the first element 201, and the angle at which the cutout part 205 is provided, to study the effects of the aspect ratio with respect to the reception rate. Results of computing the reception rate for each of Case 1, Case 2, and Case 3 are illustrated in FIG. 17.

The length of each element of the antenna conductor 101, the dimensions and the set positions of each of the parts used for the computation to obtain the results of FIG. 17 are as follows, where the dimensions are in units of mm.

Distance from the pillar 105: 10

Distance from the roof 106: 15

Circumference of semi-loop element: 300

Length of first element 201: 53

In addition, the angle at which the cutout part 205 is provided is fixed to 40 degrees.

As illustrated in FIG. 17, in all of Case 1, Case 2, and Case 3, desirable characteristics are obtained when the aspect ratio of the semi-loop element is 0.3 or greater.

<Circumference of Semi-Loop Element>

In the antenna conductor 101 illustrated in FIG. 2, the circumference of the semi-loop element is changed, without changing the distance from the pillar 105 and the distance from the roof 106 of the antenna conductor 101, the position of the first feeding part, the position of the second feeding part, the angle at which the cutout part 205 is provided, and the aspect ratio of the semi-loop element, to study the effects of the circumference of the semi-loop element with respect to the reception rate. Results of computing the reception rate for each of Case 1, Case 2, and Case 3 are illustrated in FIG. 18.

The length of each element of the antenna conductor 101, the dimensions and the set positions of each of the parts used for the computation to obtain the results of FIG. 18 are as follows, where the dimensions are in units of mm.

Distance from pillar 105: 10

Distance from roof 106: 15

In addition, the angle at which the cutout part 205 is provided is fixed to 40 degrees, and the aspect ratio of the semi-loop element is fixed to 0.875. Further, the position of the first feeding part is fixed to the upper left corner part of the semi-loop element, as illustrated in FIG. 2.

The length of the first element is multiplied by the entire length of the semi-loop shape, to correspond to the case in which the angle at which the cutout part 205 is provided becomes 40 degrees.

As illustrated in FIG. 18, in all of Case 1, Case 2, and Case 3, desirable characteristics are obtained when the entire length of the semi-loop element is in a range greater than or equal to 1.05λ_{g} and less than or equal to 1.52λ_{g}. In a case in which the ITS having the center frequency of 760 MHz is considered, the entire length of the semi-loop element is preferably in a range greater than or equal to 265 mm and less than or equal to 380 mm.

<Effects of Attached Element>

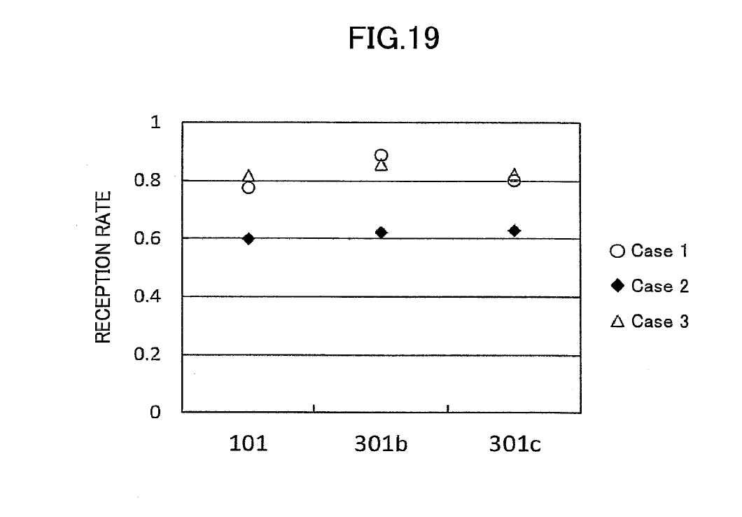

Measurements of the antenna conductor 101 illustrated in FIG. 2, the antenna conductor 301b provided with the loop forming element 304 illustrated in FIG. 3B, and the antenna conductor 301c provided with the overlap forming element 305 illustrated in FIG. 3C are performed under the same conditions, to study the effects of the loop forming element 304 and the overlap forming element 305 with respect to the reception rate. Results of computing the reception rate for each of Case 1, Case 2, and Case 3 are illustrated in FIG. 19.

The length of each element of the antenna conductors 101, 301b, and 301c, the dimensions and the set positions of each of the parts used for the computation to obtain the results of FIG. 19 are as follows, where the dimensions are in units of mm.

Circumference of semi-loop element of antenna conductors 101, 301b, and 301c: 300

aspect ratio of semi-loop element of antenna conductors 101, 301b, and 301c: 70/80

Length of first element 201: 53

Horizontal length of loop forming element 304: 15

Vertical length of loop forming element 304: 53

Length of overlap forming element 305: 38

Length of partial element 202a when overlap forming element 305 is provided: 38

Distance between partial element 202a and second feeding part 204 when overlap forming element 305 is provided: 2

In addition, the angle at which the cutout part 205 is provided in the antenna conductors 101, 301b, and 301c is fixed to 40 degrees.

In FIG. 19, the abscissa indicates the reception rate of the antenna conductors 101, 301b, and 301c for each case. As illustrated in FIG. 19, compared to the antenna conductor 101, it is confirmed that the antenna conductor 301b having the loop forming element 304 and forming a loop on one side of the semi-loop element can obtain a high reception rate in all of Case 1, Case 2, and Case 3. In addition, compared to the antenna conductor 101, it is confirmed that the antenna conductor 301c having the overlap forming element 305 and forming an overlapping part at a part other than the cutout part 205 of the semi-loop element can obtain a high reception rate in all of Case 1, Case 2, and Case 3.

According to the embodiments, it is possible to provide an antenna device having a high receiving sensitivity with respect to vertical polarized waves and having a directivity in a front direction of a vehicle, and enabling a roof-feeding.

The embodiments can provide an antenna device having a high receiving sensitivity with respect to vertical polarized waves, and is suitably applicable for use in inter-vehicle communication of automobiles.

Although the embodiments are numbered with, for example, “first,” “second,” or “third,” the ordinal numbers do not imply priorities of the embodiments. Many other variations and modifications will be apparent to those skilled in the art.

What is claimed is:

1. An antenna device comprising:
an antenna conductor provided on windshield glass;
a feeding point having a first feeding part and a second feeding part that are provided on the antenna conductor and are arranged adjacent to each other; and
an auxiliary conductor, wherein
the auxiliary conductor includes a horizontal conductor linearly provided in a horizontal direction, and a vertical conductor electrically connected to the horizontal conductor and linearly provided in a vertical direction,
the antenna conductor includes a first element that is arranged adjacent to a connecting part between the horizontal conductor and the vertical conductor and has one end connected to the first feeding part, and a second element that has one end connected to the second feeding part,
the feeding point is located at a position along the horizontal conductor of the antenna conductor,
another end of the first element and another end of the second element are arranged adjacent to each other and a cutout part is formed in a part of a loop shape, to form a semi-loop element by the first element and the second element,
the cutout part is provided on an opposite side from the horizontal conductor with respect to a horizontal line passing through a center point of a region surrounded by the semi-loop element, and on an opposite side from the vertical conductor with respect to a vertical line passing through the center point, and
a length of the first element is greater than or equal to 0.2λ_{g} and less than or equal to 0.35λ_{g}, where λ₀ denotes a wavelength in air at a center frequency of a predetermined frequency band, k denotes a wavelength shortening coefficient of the windshield glass, and λ_{g}=λ₀·k denotes a wavelength on the windshield glass.

2. The antenna device as claimed in claim 1, wherein the cutout part is provided at a position such that an angle formed by a straight line connecting the center point and an intermediate point of the cutout part and the horizontal line is in a range greater than or equal to 20° and less than or equal to 75°.

3. The antenna device as claimed in claim 1, wherein at least one of the horizontal conductor and the vertical conductor is provided on a surface of the windshield glass.

4. The antenna device as claimed in claim 1, wherein
the windshield glass is formed by laminated glass in which a first glass plate and a second glass plate are laminated via an intermediate layer, and
at least one of the horizontal conductor and the vertical conductor is provided on the intermediate layer of the laminated glass.

5. The antenna device as claimed in claim 1, wherein the horizontal conductor is formed by a flange on a roof side at a windshield opening of a vehicle, in a case in which the windshield glass is provided at the windshield opening of the vehicle.

6. The antenna device as claimed in claim 1, wherein the vertical conductor is formed by a flange on a pillar side at a windshield opening of a vehicle provided with the windshield glass at the windshield opening.

7. The antenna device as claimed in claim 1, wherein the horizontal conductor is formed by a flange on a roof side at a windshield opening of a vehicle provided with the windshield glass at the windshield opening, and the vertical conductor is formed by a flange on a pillar side at the windshield opening of the vehicle provided with the windshield glass at the windshield opening.

8. The antenna device as claimed in claim 1, wherein
a part of the antenna conductor closest to the horizontal conductor is provided at a position within 0.19λ_{g} from the horizontal conductor, and
a part of the antenna conductor closes to the vertical conductor is provided at a position within 0.27λ_{g} from the vertical conductor.

9. The antenna device as claimed in claim 1, wherein
a part of the antenna conductor closest to the horizontal conductor is provided at a position within 50 mm from the horizontal conductor, and
a part of the antenna conductor closes to the vertical conductor is provided at a position within 70 mm from the vertical conductor.

10. The antenna device as claimed in claim 1,
wherein a value obtained by dividing a height of the semi-loop element in the vertical direction by a width of the semi-loop element in the horizontal direction is greater than or equal to 0.3.

11. The antenna device as claimed in claim 1, wherein a length of the cutout part is 0.1 mm to 5 mm.

12. The antenna device as claimed in claim 1, wherein a circumference of the semi-loop element is 1.05λ_{g} to 1.5λ_{g}.

13. The antenna device as claimed in claim 1, wherein the semi-loop element includes a loop forming element that forms a loop at one of sides of the semi-loop element.

14. The antenna device as claimed in claim 1, wherein
the semi-loop element further includes an overlap forming element,
the overlap forming element has one end connected to the first feeding part or the second feeding part, and has a part extending and overlapping along one of sides of the semi-loop element, to form an overlapping part, and
the overlapping part is provided at a position where no cutout part exists.
